(19) United States
(12) Patent Application Publication
(10) Pub. No.: US 2010/0209661 A1
(43) Pub. Date: Aug. 19, 2010

(54) DRYING MAT

(75) Inventor: Jeffrey G. Wilmsen, St. Louis, MO (US)

Correspondence Address: POLSINELLI SHUGHART PC, 700 W. 47TH STREET, SUITE 1000, KANSAS CITY, MO, 64112-1802, US

(73) Assignee: SCHROEDER & TREMAYNE, INC., St. Louis, MO (US)

(21) Appl. No.: 12/569,450

(22) Filed: Sep. 29, 2009

(51) Int. Cl. B32B 3/12; B32B 5/18; B32B 3/10; B32B 7/12; B32B 37/12

(52) U.S. Cl. 428/116; 428/317.1; 428/195.1; 428/317.7; 156/60

(57) ABSTRACT

A drying mat is described. The drying mat includes layers of a microfiber material and a foam layer. The drying mat may be used as dish mat to absorb water from dishes. The dying mat may be used as a shower or bath mat to absorb water from a bather standing upon the drying mat.

In one embodiment, the drying mat includes a first microfiber layer, a second microfiber layer, a foam layer, an adhesive to join the first microfiber layer and the second microfiber layer to the foam layer; and a binding material around a perimeter of the drying mat.

Other embodiments include an absorbent or protective mat, which includes at least one layer of a microfiber material, at least one layer of a foam material, and adhesive to join the layers.

### FIELD OF INVENTION

The present invention relates to a drying mat for receiving wet dishes or that may be stood upon by an individual after bathing.

### SUMMARY OF INVENTION

A drying mat is described. The drying mat includes at least one layer of a microfiber material attached or joined to at least one layer of a foam material. The drying mat may be used as dish mat to absorb water from dishes. The drying mat may be used as a shower mat or a bath mat to absorb water from a bather standing upon the drying mat. The drying mat may also be used for drying wet or freshly washed produce and vegetables. The drying mat may also be used as a protective mat or a seat cover in a vehicle to protect a seat from damage from a child's car seat placed thereon or to absorb moisture from a passenger's swimming suit.

The drying mat may be placed under a dish drying rack to catch, hold, and/or absorb moisture and water from the dishes placed in the drying rack. Dishes may also be placed directly on the drying mat. The drying mat is machine washable. The drying mat provides a highly absorbent and fast drying alternative to a conventional dish towel, plastic drain board, or rubberized mat.

In one embodiment, a drying mat includes a first microfiber layer, a second microfiber layer, and a foam layer. An adhesive joins the first microfiber layer and the second microfiber layer to the foam layer. A binding material is applied around the perimeter of the drying mat. The drying mat includes the first microfiber layer, the second microfiber layer, and the foam layer in a layered or laminated construction.

In another embodiment, a laminated drying mat includes a first microfiber layer with a honeycomb pattern having a first surface and a second surface, a foam layer having a first and a second surface, a first adhesive layer of a non-water based adhesive that joins the second surface of the first microfiber layer to the first surface of the foam layer after heated compression, a second microfiber layer with a honeycomb pattern having a first and a second surface, and a second adhesive layer of a non-water based adhesive that joins the first surface of the second microfiber layer to the second surface of the foam layer after heated compression.

In a further embodiment, a method of forming a laminated drying mat is described. The method includes providing a first microfiber layer, a second microfiber layer, and a foam layer. Next, adhesive is applied between the first microfiber layer and the foam layer and between the second microfiber layer and the foam layer. Finally, heat and compression are applied to join the first microfiber layer, the second microfiber, and the foam layer.

In a further embodiment, absorbent and protective mats are described. Such mats may be used as seat covers for a vehicle. The mats are sized and shaped to fit on a vehicle's seat. The absorbent and protective mats include at least one layer of a microfiber material, at least one layer of a foam material, and adhesive to join the layers. The mats may be placed on the vehicle seat, with the children's car seat resting thereon. The soft and cushiony nature of the microfiber materials, along with the foam, protect the upholstery and the seat surfaces from abrasion and damage caused by the children's car seats.

### BRIEF DESCRIPTION OF DRAWINGS

FIG. 1 is a perspective view of the drying mat.

FIG. 2 is a top view of the drying mat.

FIG. 3 is a side view of the drying mat.

FIG. 4 is another side view of the drying mat.

FIG. 5 is a close-up view of the drying mat.

FIG. 6 is a cross-sectional view of the drying mat.

### DETAILED DESCRIPTION OF PREFERRED EMBODIMENTS

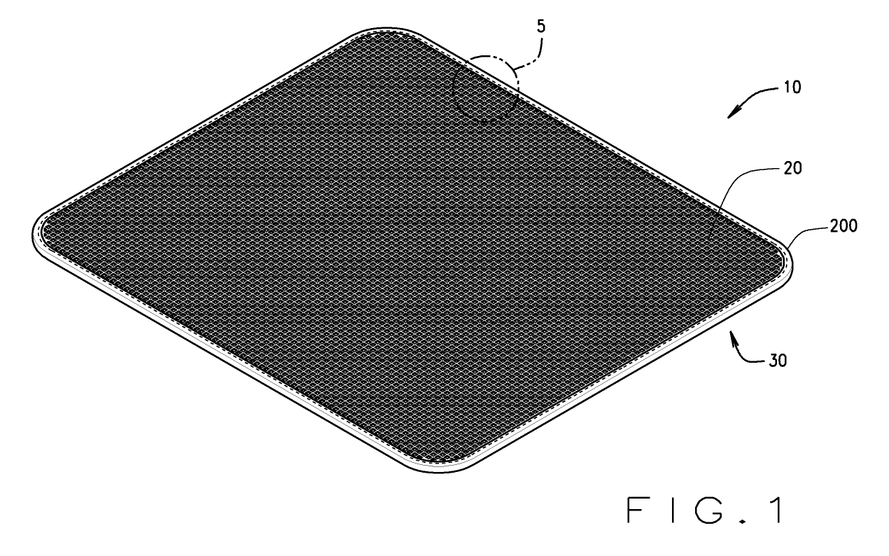

The drying mat will now be described with reference to the FIGURES. A drying mat 10 is shown in FIG. 1. The drying mat 10 may be used as a dish mat, a counter mat, a shower/bath mat, or for other applications in which an absorbent or cushioning medium is needed. The drying mat 10 absorbs significantly more water than other similarly sized mats of conventional construction.

The drying mat 10 includes a top surface 20 and a bottom surface 30. When the drying mat 10 is used as a dish mat, the wet dishes and/or the dish drying rack is placed on the top surface 20. The bottom surface 30 is placed in contact with countertop, table, etc.

The drying mat 10 includes a first microfiber layer 100, a second microfiber layer 130, and a foam layer 160 in a laminate or layered configuration. Adhesives or glues are used to join and hold the first microfiber layer 100, the second microfiber layer 130, and the foam layer 160 together.

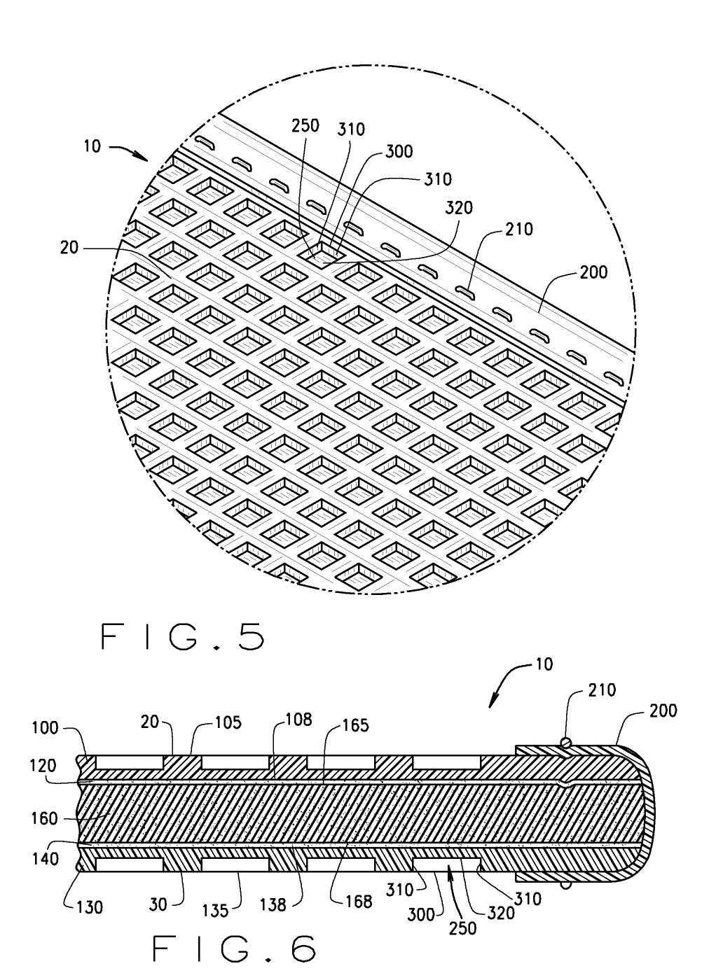

With reference to FIG. 6, a first surface 105 of the first microfiber layer 100 forms the top surface 20 of the drying mat 10. A second surface 108 of the first microfiber layer 100 is glued via a first adhesive layer 120 to a first surface 165 of the foam layer 160. A first surface 135 of the second microfiber layer 130 forms the bottom surface 30 of the drying mat 10. A second surface 138 of the second microfiber layer 130 is glued via a second adhesive layer 140 to a second surface 168 of the foam layer 160. As such, the foam layer 160 is in between the first and second microfiber layers 100 and 130.

A suitable adhesive, for the first and second adhesive layers 120 and 140, is a composite material glue, such as a polyurethane adhesive. Preferably, the adhesive is a non-water based adhesive. The amount of adhesive applied between the first microfiber layer 100 and the foam layer 160 (forming the first adhesive layer 120) and between the second microfiber layer 130 and the foam layer 160 (forming the second adhesive layer 140) is important. Too much adhesive in the first and second adhesive layers 120 and 140, and the drying mat 10 becomes stiff. Too little adhesive in the first and second adhesive layers 120 and 140, and the microfiber layers 100 and 130 and the foam layer 160 will tend to delaminate. Typically, approximately 30 g/m² to approximately 50 g/m² of adhesive is applied to the first and second microfiber layers 100 and 130. The embodiment shown in the FIGURES utilizes approximately 40 g/m² for the first and second adhesive layers 120 and 140.

Although the term “adhesive layer” is used, the term adhesive layer encompasses the intermittent spraying or partial coating of the adhesive to the microfiber layers or foam layer, as well as the spot application of the adhesive to the microfiber layers or to the foam layer. In other embodiments, the adhesive layer may fully or nearly fully coat the microfiber layers or the foam layer.

A binding 200 affixes or connects together the perimeter portions or edges of the first microfiber layer 100, the second microfiber layer 130, and the foam layer 160. The binding 200 may be applied using an over-edging machine at a rate of approximately 5 stitches/inch. The binding 200 may be a polyester, microfiber, polyamide, satin, cotton, synthetic, nylon, or other durable material. The binding 200 is attached to the microfiber layers 100 and 160 via stitching 210.

When used as a shower mat, the fibers in the microfiber of the drying mat 10 are in frictional contact with the bathroom floor. The porous nature of the microfiber layers 100 and 130 essentially forms a vacuum/suction grip on the substrate, e.g., the bathroom floor, to hold the drying mat 10 securely to the substrate. Also, the drying mat 10 absorbs water, which adds to the weight of the drying mat 10. The extra weight of the drying mat 10 assists in holding the position of the drying mat 10 on the floor so that the drying mat 10 does not slip.

The size of the drying mat 10 may vary depending upon its intended purpose. Typically, the first microfiber layer 100, the second microfiber layer 130, and the foam layer 160 will all generally have approximately the same overall length and width. A dish mat may have a size of approximately 12 inches to approximately 22 inches in width by approximately 14 inches to approximately 36 inches in length. Typical embodiments of the dish mat have a size of approximately 16 inches by approximately 18 inches or approximately 18 inches by approximately 24 inches. Typical embodiments of the counter-top mat have a size of approximately 18 inches by approximately 32 inches. Typical embodiments of the shower mat have a size of approximately 18 inches by approximately 24 inches.

The first microfiber layer 100 and the second microfiber layer 130 have a thickness of approximately 3 mm to approximately 7 mm. In the embodiment shown in the FIGURES, the first microfiber layer 100 and the second microfiber layer 130 have a thickness of approximately 5 mm. The soft and cushiony nature of the microfiber layers 100 and 130 cushions delicate stemware and glasses. The soft and cushiony nature of the microfiber layers 100 and 130 protects the counter-top from contact with the drying dishes and cooking utensils. Certain pots and pans may scratch or ding some counter-top materials. The drying mat 10 may also be used as a protective support on the counter-top for appliances, like a mixer, blender, food processor, etc. to protect the counter-top from scratches and scuffs.

The foam layer 160 has a thickness of approximately 0.4 centimeters to approximately 0.8 centimeters. If the foam layer 160 is too thin, then the drying mat 10 will loose some of its absorbency. If the foam layer 160 is too thick, then the dishes, such as drinking glasses, may tip over when placed on the drying mat 10. The foam layer 160 absorbs water, as well as cushioning the dishes placed thereon.

The drying mat 10 may be placed under a dish drying rack to catch, hold, and/or absorb moisture and water from the dishes placed in the drying rack. Dishes may also be placed directly on the drying mat 10. The drying mat 10 is machine washable. The drying mat 10 provides a highly absorbent and fast drying alternative to a conventional dish towel, plastic drain board, rubberized mat.

The drying mat 10 provides a water absorbent structure that will absorb up to approximately 4 to 5 times its own weight in water. For example, a 16 inch by 18 inch drying mat 10 weighs approximately 150 to 155 grams. As such, this particular drying mat 10 will absorb up to approximately 26 ounces of water. Of course, one of ordinary skill in the art will recognize that the amount of absorption will depend on the size of the drying mat 10.

The first microfiber layer 100 and the second microfiber layer 130 may include a honeycomb pattern. The honeycomb pattern increases the surface area of the layer of microfiber 100 and 130 as compared to a flat sheet of microfiber. The increased surface area promotes water absorption into the microfiber layers 100 and 130, as well as the drying of the microfiber layers 100 and 130.

With reference to FIGS. 5 and 6, the honeycomb pattern forms a grid or matrix of squares 300 in the top and bottom surface 20 and 30 of the first microfiber layer 100 and the second microfiber layer 130. A central region of each square 300 includes a depression 250, which provides a hollow void interior to the square 300. All or essentially all of the squares 300 include the depression 250. The squares 300 adjacent to the binding 200 may have their depressions 250 fully or partially covered or blocked by the binding 200.

The depressions 250 generally extend into the top and bottom surface 20 and 30. The depressions 250, through gravity and wicking action of the microfiber material, receive and direct beads of water and moisture into the interior of the drying mat 10 and toward the foam layer 160. Each depression 250 includes sidewalls 310 leading to an interior surface 320 of the depression 250. The sidewalls 310 connect either the top surface 20 or the bottom surface 30, respectively, with the interior surface 320 of the depression 250.

The honeycomb pattern comprises approximately 50,000 to approximately 150,000 depressions 250 per square meter of the first and second microfiber layers 100 and 130. In the embodiment shown in the FIGURES, the honeycomb pattern comprises approximately 100,000 depressions 250 per square meter of the first and second microfiber layers 100 and 130. Each depression 250 is approximately 0.3 mm to approximately 2 mm in depth. In the embodiment shown in the FIGURES, the each depression 250 is approximately 1 mm in depth, i.e., there is a distance of approximately 1 mm between the interior surface 320 and either the top surface 20 or the bottom surface 30, respectively. Each depression 250 is approximately 3 mm by approximately 3 mm in width. In other embodiments, the width of the depressions 250 may range from approximately 2 mm to approximately 25 mm.

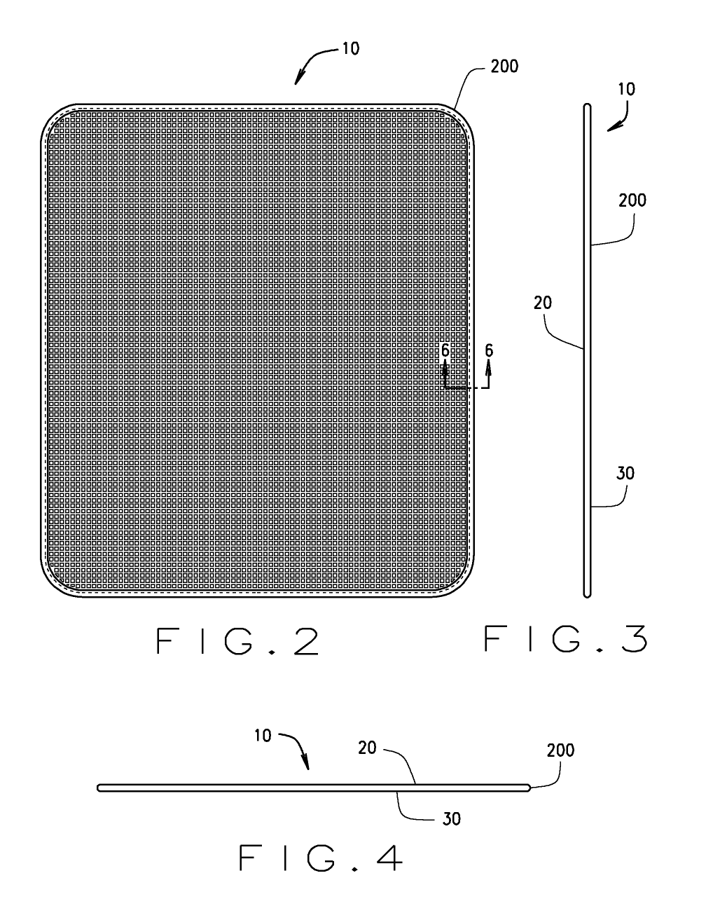

Although a honeycomb pattern is shown in FIGS. 1-6, other patterns or plain surface types of microfiber material may be used for the first and second microfiber layers 100 and 130. For example, a waffle pattern, a terry pattern, a circular a knit pattern, a flat loop pattern, a suede pattern or a herringbone pattern may be used in forming the drying mat 10. Also, a non-woven microfiber material may be used in forming the microfiber layers 100 and 130. The honeycomb pattern may also form a matrix of rectangles instead of the squares 300. Patterns of microfiber containing circular, ovular, geometric, or non-geometric shapes and designs of depressions may also be utilized. Microfiber materials having patterns, which increase surface area for the drying mat 10, such as the honeycomb pattern, are well suited for use in the drying mat 10. The increased surface area promotes absorption of water into the drying mat 10 and the drying of the drying mat 10.

The foam layer 160 may include a variety of different foam materials, such as polyester, polyether, polyvinyl alcohol, cellulose, natural foam, and synthetic foam materials. The foam layer 160 forms a porous structure to absorb water. One type of suitable foam material are foams from the demospongea class of foams. Such foams may have a density of approximately 18 to approximately 20 kg/m³. Such foams have a hydrophilic action that helps absorb water into the drying mat 10.

The first microfiber layer 100 and the second microfiber layer 130 comprise polyester and polyamide in a range of approximately 65% to approximately 95% polyester to approximately 35% to approximately 5% polyamide. One embodiment includes approximately 80% polyester and 20% polyamide. An increased amount in the polyamide content provides for a softer and more absorbent microfiber. The individual fibers of the microfiber used in the first and second microfiber layers 100 and 130 generally have a thickness of 0.1 denier or less. The high number of individual fibers in the microfiber material forming the first microfiber layer 100 and the second microfiber layer 130 promote the absorption of water into the drying mat 10, as well as the ability of the drying mat 10 to dry quickly.

The drying mat 10 typically has a rectangular shape. The drying mat 10 may include rounded corners. The drying mat 10 may be provided in different colors depending upon consumer preference.

A process used to manufacture the drying mat 10 will now be described. The first microfiber layer 100 and the second microfiber layer 130 are bonded to the foam layer 160 using heated compression. Other embodiments may utilize a flame type compression. In detail, the first microfiber layer 100 is provided. The second microfiber layer 130 is provided. The foam layer 160 is provided. An adhesive is applied to join the first microfiber layer 100 and the second microfiber layer 130 to the foam layer 160. Specifically, the adhesive is applied between the first microfiber layer 100 and the foam layer 160 to form the first adhesive layer 120, and the adhesive is applied between the second microfiber layer 130 and the foam layer 160 to form the second adhesive layer 140. Heat and compression are applied to join the first microfiber layer 100, the second microfiber layer 130, and the foam layer 160. The binding material 200 is applied around the perimeter via a sewing machine.

The drying mat 10 may also be used as a protective mat or seat cover in a vehicle to protect the seat from damage from a child's car seat placed thereon or to absorb moisture from a passenger's swimming suit. The protective mat or seat cover includes at least one layer of a microfiber material, at least one layer of a foam material, and adhesive to join the layers. The drying mat 10 may be used as the protective mat without further alteration. However, the drying mat 10 may be dimensioned to fit on top of the seats of the vehicle.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A drying mat, comprising:
a first microfiber layer;
a second microfiber layer;
a foam layer; and
an adhesive to join the first microfiber layer and the second microfiber layer to the foam layer.

2. The drying mat according to claim 1, wherein the foam layer comprises a first surface and a second surface, and the adhesive forms adhesive layers between the foam layer and the first microfiber layer and between the foam layer and the second microfiber layer.

3. The drying mat according to claim 1, wherein a first surface of the first microfiber layer forms a top surface of the drying mat, a second surface of the first microfiber layer is glued via a first adhesive layer of the adhesive to a first surface of the foam layer, a first surface of the second microfiber layer forms a bottom surface of the drying mat, and a second surface of the second microfiber layer is glued via a second adhesive layer of the adhesive to a second surface of the foam layer.

4. The drying mat according to claim 1, wherein the drying mat is a dish mat, a counter mat or a shower mat.

5. The drying mat according to claim 1, wherein the drying mat has a rectangular shape.

6. The drying mat according to claim 1, wherein the foam is a material selected from the group consisting of polyester, polyether, polyvinyl alcohol, cellulose, natural foam, and synthetic foam.

7. The drying mat according to claim 1, wherein the foam has a thickness of approximately 0.4 centimeters to approximately 0.8 centimeters.

8. The drying mat according to claim 1, wherein the first microfiber layer and the second microfiber layer comprise polyester and polyamide.

9. The drying mat according to claim 8, wherein the first microfiber layer and the second microfiber layer comprise the polyester and the polyamide in amount of approximately 80% of the polyester and approximately 20% of the polyamide.

10. The drying mat according to claim 1, wherein the first microfiber layer and the second microfiber layer comprises a pattern or a design.

11. The drying mat according to claim 1, wherein the first microfiber layer and the second microfiber layer comprise a honeycomb pattern.

12. The drying mat according to claim 11, wherein the honeycomb pattern forms a grid or matrix of squares, wherein essentially all of the squares contain a depression.

13. The drying mat according to claim 11, wherein the honeycomb pattern comprises approximately 50,000 to approximately 150,000 depressions per square meter of the first and second microfiber layers.

14. The drying mat according to claim 12, wherein a width of the depressions ranges from approximately 2 mm to approximately 25 mm, and wherein a depth of the depressions ranges from approximately 0.3 mm to approximately 2 mm.

15. The drying mat according to claim 1, wherein a binding material is around a perimeter of the drying mat, wherein the binding material is a material selected from the group consisting of polyester, microfiber, polyamide, satin, cotton, synthetic, and nylon.

16. The drying mat according to claim 1, wherein approximately 30 g/m² to approximately 50 g/m² of adhesive is applied per square inch of microfiber material.

17. The drying mat according to claim 1, wherein the adhesive is a non-water based adhesive.

18. The drying mat according to claim 18, wherein the non-water based adhesive is a polyurethane adhesive.

19. A laminated drying mat, comprising:
a first microfiber layer with a honeycomb pattern having a first surface and a second surface;
a foam layer having a first and a second surface;
a first adhesive layer of a non-water based adhesive that joins the second surface of the first microfiber layer to the first surface of the foam layer after heated compression;
a second microfiber layer with a honeycomb pattern having a first and a second surface; and
a second adhesive layer of a non-water based adhesive that joins the first surface of the second microfiber layer to the second surface of the foam layer after heated compression.

20. The laminated drying mat according to claim 19, wherein the first surface of the first microfiber layer forms a first outer surface of the laminated drying mat and the second surface of the second microfiber layer forms a second outer surface of the laminated drying mat.

21. A mat, comprising:
at least one microfiber layer;
at least one adhesive layer; and
at least one foam layer; wherein the at least one foam layer is attached or glued to the at least one microfiber layer via the at least one adhesive layer.

22. The mat according to claim 21, wherein the mat is a seat cover for a vehicle.

23. A method of forming a laminated drying mat, comprising:
providing a first microfiber layer;
providing a second microfiber layer;
providing a foam layer;
applying an adhesive between the first microfiber layer and the foam layer and between the second microfiber layer and the foam layer; and
applying heat and compression to join the first microfiber layer, the second microfiber, and the foam layer.

24. The method of forming a laminated drying mat according to claim 23, further comprising:
applying a binding material around a perimeter of the joined first microfiber layer, the second microfiber layer, and the foam layer.
